(19) United States
(12) Patent Application Publication
(10) Pub. No.: US 2014/0009429 A1
(43) Pub. Date: Jan. 9, 2014

(54) METHOD OF PRODUCING CAPACITIVE COPLANAR TOUCH PANEL DEVICES WITH LASER ABLATION

(71) Applicants: Frans VERWEG, Chu-Nan (TW); Edward REIJNEN, Chu-Nan (TW)

(72) Inventors: Frans VERWEG, Chu-Nan (TW); Edward REIJNEN, Chu-Nan (TW)

(73) Assignees: CHIMEI INNOLUX CORPORATION, Chu-Nan (TW); INNOCOM TECHNOLOGY (SHENZHEN) CO., LTD., Shenzhen City (CN)

(21) Appl. No.: 13/541,501

(22) Filed: Jul. 3, 2012

(51) Int. Cl. G06F 3/044; H01H 11/00

(52) U.S. Cl. 345/174; 29/622

(57) ABSTRACT

The invention relates to a method of manufacturing a capacitive coplanar touch panel device based on the following actions:
a) Providing a glass sheet having a first size,
b) Cutting the glass sheet in glass sheet pieces having a second size smaller than the first size,
c) Hardening the glass sheet pieces to a desired level of hardness,
d) Applying a transparent conductive layer with a predetermined thickness on a side of at least one glass sheet piece,
e) Applying a laser ablation process on the transparent conductive layer such as to provide the transparent conductive layer with a predetermined pattern.

### FIELD

The invention relates to the production of capacitive coplanar touch panel devices.

### BACKGROUND

Capacitive touch panels are widely used to allow user interaction with electronic devices. In particular, a transparent touch panel can be used on top of a display device to allow a user to interact with the display device, e.g. to respond to a query shown as a pop-up on the display device by touching the displayed query, to select an item from a menu shown on the display device by touching a selected item, to scroll through a list of items, or even to provide a free-format input, e.g. draw an object on the display device, such as hand-written characters for inputting text. Touch panels are e.g. used in mobile (smart) phones, portable media players, gaming devices and other portable consumer appliances or user interfaces with devices like printers, copiers, scanners, and the like, as well as with e.g. computer displays. Touch panels as explained below with reference to the current invention can be applied in such and equivalent devices too.

In prior art touch panel devices, a touch sensor substrate glass with a patterned ITO layer (or other transparent conductive layer) would be applied having a cover plate, e.g. made of glass, on top of it. In accordance with prior art manufacturing methods of touch panel devices, one would produce the touch sensor substrate glass with such an ITO layer as follows:
1. Provide a larger sheet of glass,
2. Sputter ITO material on at least one side with a desired thickness,
3. Apply a lithography process on the ITO layer to produce a patterned ITO layer,
4. Cut the larger glass sheet with patterned ITO layer in smaller pieces having a desired size for the intended application, like a touch screen of a smartphone.

In step 3, in principle, other methods could be used to pattern the ITO layer. However, nowadays nobody applies other techniques since they are much more expensive than (standard) lithography processes.

In order to make such touch sensitive devices thinner and reduce the integral cost price it has been proposed to integrate a first layer of sensor elements on a backside of the cover plate, cf. US 2010/0097344. This may be called a “window integrated type” touch panel. The backside is defined as the side of the cover plate not facing the user in use. In such an arrangement, the cover plate functions both as protective cover and as substrate for the touch sensitive sensors. However, sometimes one would wish to use a glass type for the cover plate that should be hardened before being used in the final device. This would for instance apply to the following glass types that are nowadays widely used: Dragontrail from Asahi or Gorilla Glass from Corning. A problem may then arise in the sense that the hardening action should be done after the singulation of the large glass plate, in order to keep/have the desired strength of the glass. However, due to the necessary high temperatures, the hardening action can not be performed when the ITO layer is already applied. Therefore, the ITO layer has to be applied and patterned on single pieces, after the singulation and hardening. The problem that arises is that patterning by means of lithography will be too expensive on single pieces. Therefore, another method of patterning needs to be applied.

### SUMMARY

To solve this, the present invention proposes the following a method of manufacturing a coplanar touch panel device comprising at least the following actions:
a) Providing a glass sheet having a first size,
b) Cutting the glass sheet in glass sheet pieces having a second size smaller than the first size,
c) Hardening the glass sheet pieces with said second size to a desired level of hardness,
d) Applying a transparent conductive layer with a predetermined thickness on a side of at least one glass sheet piece with said second size,
e) Applying a laser ablation process on the transparent conductive layer such as to provide the transparent conductive layer with a predetermined pattern and thus rendering an at least one glass sheet piece with a patterned transparent conductive layer.

Applying laser ablation to pattern the transparent conductive layer on the cut smaller sized glass sheets with the second size (i.e. the size for the intended touch panel application) has turned out to be surprisingly advantageous since the risk of damaging the small vulnerable glass sheets is lower than with lithographic methods and when applied on small screens it is even cheaper.

In an embodiment, the invention relates to a touch panel device comprising a window plate having a laser-ablated patterned transparent conductive layer on its back surface, the patterned transparent conductive layer providing a touch sensitive interface area.

In a further embodiment, the invention provides an apparatus provided with such a touch panel device, being apparatus being one of a smartphone, a tabloid personal computer, a digital still-picture camera, a car navigation system, a DVD/blu ray-player, a gaming device, a tabloid computer monitor, a printer, a scanner and copier.

### BRIEF DESCRIPTION OF DRAWINGS

These and other aspects of the invention will be further elucidated and described in detail with reference to the drawings, in which corresponding reference symbols indicate corresponding parts:

FIG. 1a and FIG. 1b schematically show an apparatus having a capacitive touch screen on top of a display device;

FIG. 2a and FIG. 2b schematically show a capacitive touch sensor and a display device in an apparatus according to the prior art in which the patterned transparent conductive layer is not yet integrated in the glass cover plate but applied on a touch sensor substrate glass below the cover plate;

FIG. 3a, FIG. 3b and FIG. 3c schematically show alternative configurations of a capacitive touch sensor and a display device of a window integrated type;

FIG. 4 schematically shows a further alternative capacitive touch sensor and a display device of a window integrated type;

FIG. 5 shows a top view of an embodiment of the touch panel device in which the sensor cells are schematically indicated;

FIGS. 6a and 6b show examples of conductive tracks providing the routing between the sensor cells and the sensor controller;

FIGS. 7a to 7f show examples of apparatuses that can be used in a laser ablation method

FIG. 8 shows an example of a non-flat capacitive touch panel.

### DETAILED DESCRIPTION

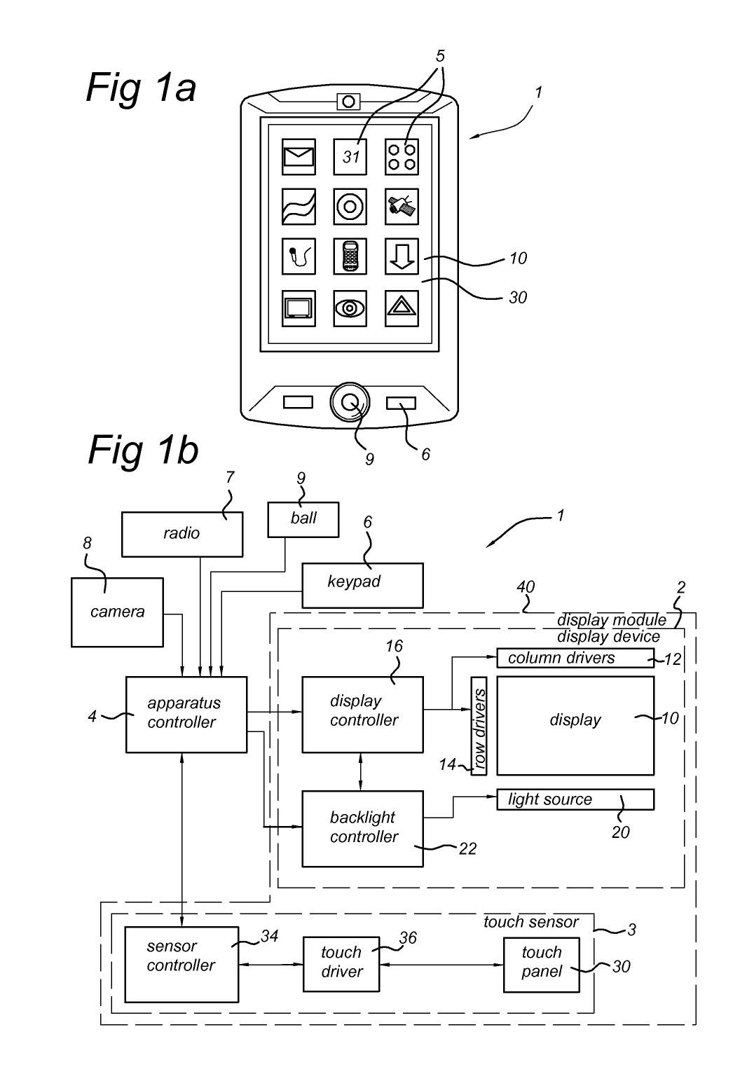

FIGS. 1a and 1b schematically show an apparatus 1 in which the glass cover plate with patterned ITO (or other transparent conductive layer) manufactured in accordance with the invention can be applied. The apparatus 1 comprises a display device 2, a capacitive touch sensor 3, and an apparatus controller 4 arranged to operate the capacitive touch sensor 3 and to operate the display device 2. The arrangement of display device 2 and capacitive touch sensor 3 may be referred to as a display module 40.

The apparatus 1 may further comprise e.g. a keypad 6 arranged for accepting user input for controlling the apparatus 1, a radio 7 arranged for sending and receiving messages such as voice messages, text messages and/or images, and a camera 8 arranged for taking images, and a scroll ball 9 for accepting further user input for controlling the apparatus 1.

The apparatus 1 may e.g. be a mobile (smart) phone, as shown in FIG. 1a, a digital still-picture camera, a car navigation system, a mobile DVD/blu ray-player, a gaming device, or another hand-held consumer appliance, a tabloid computer monitor, or a professional appliance like a printer, a scanner or copier.

The display device 2 comprises a display 10 comprising a plurality of pixels arranged to be driven with pixel drive values, and a display controller 16 arranged to receive color input values of input image pixels of an input image and to drive the display 10 with pixel drive values. The display controller 16 is in electrical communication with column drivers 12 and row drivers 14, for driving the plurality of pixels of the display 10 with the pixel drive values according to known methods. The display controller 16 may be arranged to receive an input image from the apparatus controller 4 and use said input image to drive the display 10. The input image may alternatively be generated, as a whole or part of it, by the display controller 16, e.g. for providing test images. The input image may e.g. represent a menu, which may e.g. be displayed on the display using a set of icons 5. In the example shown, the display device further comprises a light source 20 and a backlight controller 22. The backlight controller 22 is in electrical communication with the display controller 16 and/or the apparatus controller 4, and with the light source 20. The light source 20 is arranged to illuminate the display 10 when driven by the backlight controller 22. In this example, the display 10 is an LCD display. It is appreciated that an alternative display 10 may be an OLED display, in which case the light source 20 and backlight controller 22 are omitted.

The capacitive touch sensor 3 comprises a transparent touch panel 30, a sensor controller 34 and a touch driver 36. The sensor controller 34 is in electrical communication with the touch driver 36 connected to the electrodes (not shown) on the touch panel 30, for operating the touch panel 30 according to known methods. The sensor controller 34 may in particular be arranged to detect a position on the touch panel 30 of a touch input to the touch panel 30. In alternative embodiments, the sensor controller 34 may just be arranged to detect whether the touch panel 30 is touched or not.

The display 10 is positioned behind the touch panel 30, allowing a user to see the display 10 through the touch panel 30. When the display 10 shows a menu with icons 5, the user can thus see the icons 5 and touch a selected icon using his finger or e.g. a stylus for selecting the icon. When the icon 5 represents an application, the processing application may be launched when the icon is selected and the user may use his finger, or the stylus, to input information to the touch panel 30, thus composing an image associated with the information which is displayed on the display 10. The application may e.g. comprise a text processing application. The text processing application may comprise character recognition for transforming inputted handwritten characters to formatted text. The formatted text may then be displayed on the display. The application may e.g. comprise a drawing application. The drawing application may comprise acquiring inputted drawing elements, such as lines, and showing the drawing elements on the display. It will be appreciated that alternative modes of operating the touch panel 30 and alternative modes of cooperation between the display device 2 and the touch sensor 3 may be used in addition or in stead of the described modes.

It will be appreciated that the blocks shown in FIG. 1b may be implemented as individual hardware units, but that various blocks may alternatively be integrated into a single hardware unit. E.g., the display controller 16 and the sensor controller 34 may be integrated in a combined controller unit.

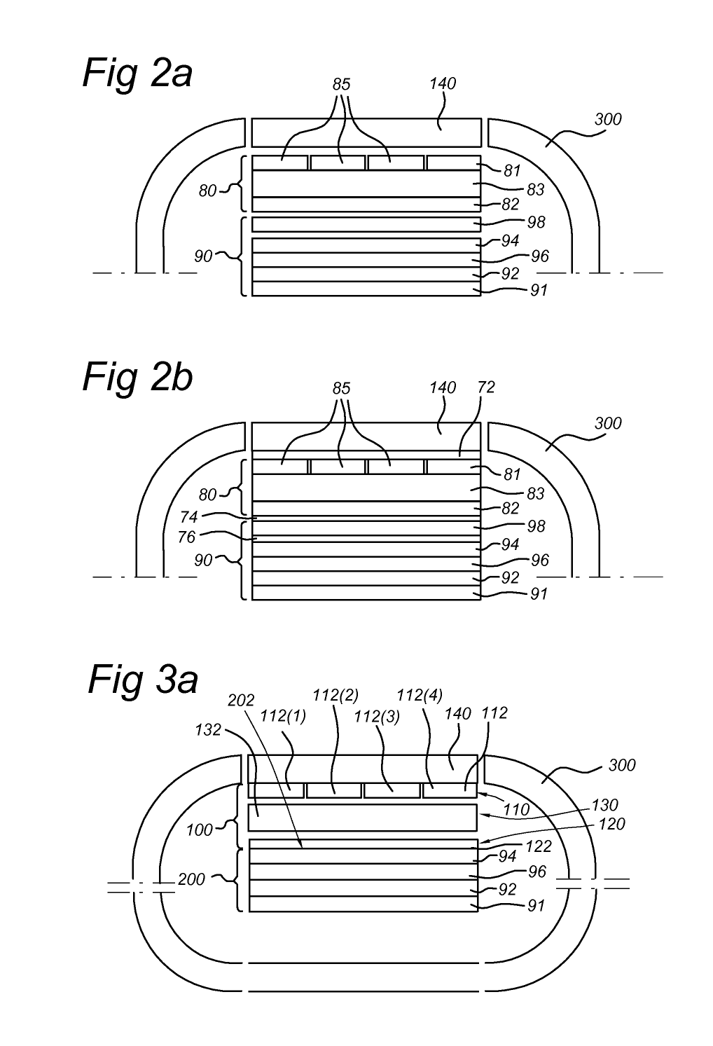

FIGS. 2a/2b schematically show prior art configurations of a capacitive touch sensor 80 and a display device 90 in an apparatus 1. In the device of FIGS. 2a/2b there is a separate glass plate with patterned ITO (or other transparent conductive) layer below a covering window plate. It is observed that hereinafter the patterned transparent conductive layer will be referred to as “ITO” layer 112. However, this layer may be made of any other suitable transparent conductive layer known to persons skilled in the art, for instance, a transparent conductive organic layer.

The apparatus 1 comprises a housing 300 having a transparent window plate 140 covering the capacitive touch sensor 80 for protecting the capacitive touch sensor 80 and for allowing a user to view the display 10 through the transparent window plate 140 and the capacitive touch sensor 80. The transparent window plate 140 has a thickness between 0.5 and 4 mm, preferably between 0.5 and 1.5 mm, for instance 0.7 mm, with a thickness tolerance of 0.05 mm. The capacitive touch sensor 80 comprises a transparent glass plate 83. A first electrode 81 comprising a plurality of first sensor elements 85 is provided on the glass plate 83 at a front side of the capacitive touch sensor 80, i.e. at the side facing the transparent window plate 140. A second electrode 82 is provided as a single electrode on the glass plate 83 at a back side of the capacitive touch sensor 80, i.e. at the side facing the display device 90.

The first electrode 81 and the second electrode 82 are composed of a transparent conductive material, e.g. ITO. The plurality of first sensor elements 85 is e.g. made by patterning an ITO layer provided on the glass plate 83, as will be explained in more detail hereinafter. The plurality of first sensor elements 85 and the second electrode 83 are connected via the touch driver 36 to the sensor controller 34 (connections not shown). The sensor controller 34 is arranged to determine a position on the capacitive touch sensor of a touch input provided by a user to the transparent window plate 140, coupling to the capacitive touch sensor 80, from the plurality of first sensor elements 85 of the first electrode 81 and the second electrode 82 using e.g. known methods. The second electrode 82 acts as a shielding between the capacitive touch sensor 80 and the display device 90, and aims to prevent disturbances in the capacitive touch sensor 80 caused by operating the display device 90 or other components in the apparatus 1.

The display device 90 is a known LCD-type display comprising, in this example, a back plate 92 comprising an active matrix of pixels, a front plate 94, a polarizer 98, an LCD layer 96 sandwiched between the back plate 92 and front plate 94, and a backlight system 91. The polarizer 98 is provided at a front side of the display device 90. The backlight system 91 delivers polarized light to the back plate 92. The backlight 91 system may e.g. comprise a wave guide parallel to the back plate, a light source arranged at a side of the wave guide for emitting light into the waveguide, and an input polarizer between the wave guide and the back plate 92 for delivering polarized light to the back plate 92.

The arrangement of the capacitive touch sensor 80 with the display device 90 may be referred to as a display module. The known display module of FIG. 2 thus comprises a plurality of relatively thick optically transparent layers: the transparent window plate 140, the glass plate 83 of the capacitive touch sensor 80, the polarizer 98, the front plate 94 and the back plate 92. Each of these optically transparent layers may adversely affect an optical quality of the image being viewed through them by a user, especially at the interfaces between two layers.

In FIG. 2a, the transparent window plate 140, the capacitive touch sensor 80 and the display device 90 are shown with a first small spacing in between the transparent window plate 140 and the capacitive touch sensor 80 and a second small spacing in between the capacitive touch sensor 80 and the display device 90. These spacings are drawn to indicate that the transparent window plate 140, the capacitive touch sensor 80 and the display device 90 need not be laminated together, but may e.g. be clamped together to be in close contact or with a marginal spacing only.

FIG. 2b schematically shows a similar prior art configuration of a capacitive touch sensor 80 and a display device 90 in an apparatus 1. In comparison with the prior art configuration of FIG. 2a, the prior art configuration of FIG. 2b comprises a first optically clear adhesive layer 72 in between the transparent window plate 140 and the capacitive touch sensor 80 instead of the first small spacing of FIG. 2a. The first optically clear adhesive layer 72 provides mechanical and optical contact between the transparent window plate 140 and the capacitive touch sensor 80. The prior art configuration of FIG. 2b further comprises a second optically clear adhesive layer 74 in between the capacitive touch sensor 80 and the display device 90 instead of the second small spacing of FIG. 2a. The second optically clear adhesive layer 74 provides mechanical and optical contact between capacitive touch sensor 80 and the display device 90. FIG. 2b further shows that the polarizer 98 may be laminated with a third optically clear adhesive layer 76 to the front plate 94 of the LCD-type display.

In accordance with prior art manufacturing methods of touch panel devices, one would produce the glass plate 83 with ITO layer 81 as follows:
1. Provide a larger sheet of glass,
2. Sputter ITO material on at least one side with a desired thickness,
3. Apply a lithography process on the ITO layer to produce a patterned ITO layer, i.e. the first sensor elements 85,
4. Cut the larger glass sheet with patterned ITO layer in smaller pieces having a desired size for the intended application, like a touch screen of a smartphone.

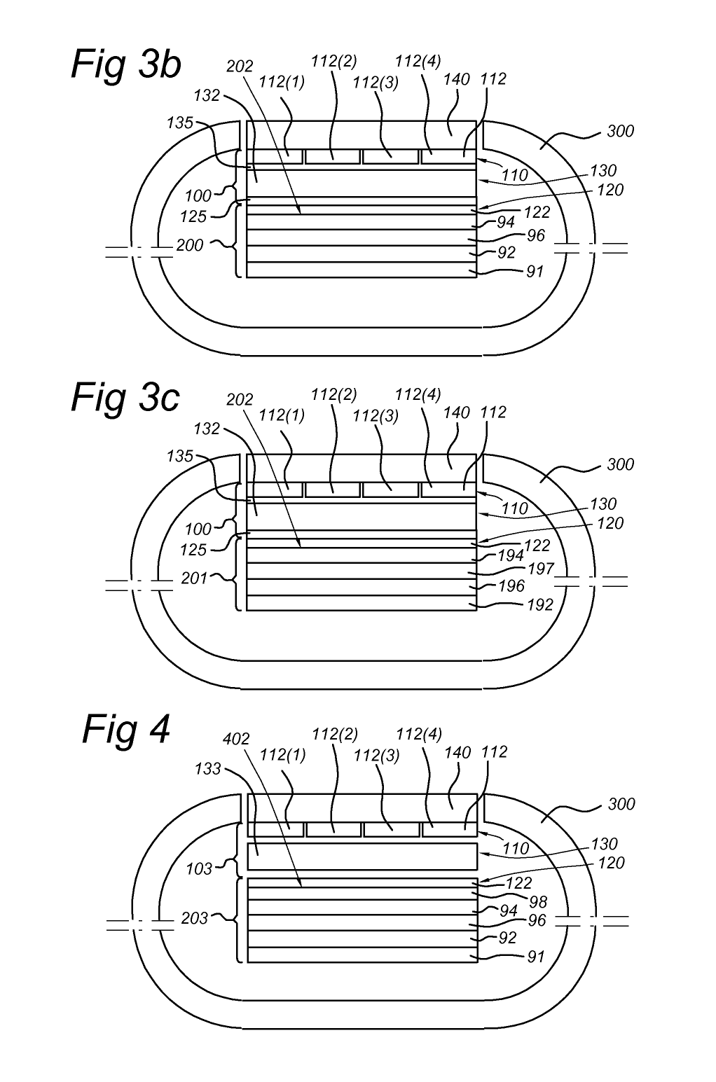

FIG. 3a schematically shows a configuration of a capacitive touch sensor 100 and a display device 200 in an apparatus 1 according to a window integrated type.

The apparatus 1 comprises a housing 300 having a transparent window plate 140 covering the capacitive touch sensor 100 for protecting the capacitive touch sensor 100. The capacitive touch sensor 100 comprises a polarizer 132 forming a sensor dielectric layer 130. A first electrode 112 comprising a plurality of first sensor elements 112(1)-112(4) is provided on the transparent window plate 140 in a first sensor electrode layer 110 at a back side of the transparent window plate 140. A second electrode 122 is provided as a single electrode in a second sensor electrode layer 120 on a front surface 202 of the display device 200, and more specifically, in this example, on a front surface 202 of the front plate 94 of the display device 200.

The second electrode 122 is composed of a transparent conductive material, e.g. ITO. In alternative embodiments, the second electrode 122 comprises a thin metal layer, e.g. Au, or a transparent conductive organic layer. The plurality of first sensor elements 112(1)-112(4) and the second electrode 122 are connected via the touch driver 36 to the sensor controller 34 (connections not shown). The sensor controller 34 is arranged to determine a position of a touch input to the transparent window plate 140, coupling to the capacitive touch sensor 100, from the plurality of first sensor elements 112(1)-112(4) of the first electrode 112 and the second electrode 122 using e.g. known methods.

The sensor controller 34 may be arranged to provide the first electrode 112 with a sensor voltage waveform for charging and/or discharging the first electrode 112, provide the second electrode 122 with the sensor voltage waveform for charging and/or discharging the second electrode 122, detect a charging and/or discharging behavior of the first electrode 112 upon providing the first electrode 112 with the sensor voltage waveform, detect a corresponding charging and/or discharging behavior of the second electrode 122 upon providing the second electrode 122 with the sensor voltage waveform, and determine a touch input characteristic associated with the touch input from a comparison of the charging and/or discharging behavior of the first electrode 112 and the charging and/or discharging behavior of the second electrode 122. The sensor controller may be arranged to determine a position of the touch input to the capacitive touch sensor 100 from the touch input characteristic. The sensor controller 34 may be arranged to detect a charging and/or discharging behavior of each of at least two first sensor elements 112(1)-112(4) upon providing the first electrode 112 with the sensor voltage waveform, and determine the position of the touch input to the capacitive touch sensor 100 from the touch input characteristic associated with the touch input from a comparison of the charging and/or discharging behavior of the at least two first sensor elements 112(1)-112(4) of the first electrode 112 and the charging and/or discharging behavior of the second electrode 122.

The second electrode 122 acts as a shielding between the capacitive touch sensor 100 and the display device 200, and aims to prevent disturbances in the capacitive touch sensor 100 caused by operating the display device 200.

The display device 200 is a LCD-type display comprising, in this example, a back plate 92 comprising an active matrix of pixels, a front plate 94, an LCD layer 96 sandwiched between the back plate 92 and front plate 94, and a backlight system 91. The backlight system 91 delivers polarized light to the back plate 92. The backlight 91 system may e.g. comprise a wave guide parallel to the back plate 92, a light source (not shown in FIG. 3a) arranged at a side of the wave guide for emitting light into the waveguide, and an input polarizer between the wave guide and the back plate 92 for delivering polarized light to the back plate 92, as is known to persons skilled in the art. In comparison with the display device shown in FIG. 2a, the display device 200 lacks the polarizer 98; the function of the polarizer 98 is now performed by the sensor dielectric layer 130 in the capacitive touch sensor 100.

The window integrated type display module of FIG. 3a comprises less relatively thick optically transparent layers compared to the display module of FIG. 2a. In particular, the display module of FIG. 3a lacks the glass plate 83 of FIG. 2a. As a result, the display module of FIG. 3a may be thinner than the display module of FIG. 2a, and the display module of FIG. 3a may have an improved image quality compared to the display module of FIG. 2a.

It will be appreciated that the first sensor electrode layer 110 and the sensor dielectric layer 130 may be in direct contact, or alternatively be separated at a small distance as shown in FIG. 3a. It will be appreciated that the sensor dielectric layer 130 and the second sensor electrode layer 120 may be in direct contact, or alternatively e.g. be separated at a small distance as shown in FIG. 3a.

FIG. 3b schematically shows an alternative window integrated type configuration of a capacitive touch sensor 100 and a display device 200 for an apparatus 1.

The configuration of FIG. 3b is similar to that of FIG. 3a, but in addition comprises a first optically transparent adhesive layer 135 between the transparent window plate 140 with the first sensor electrode layer 110 and the polarizer 130. The first optically transparent adhesive layer 135 may fully laminate the polarizer 130 to the transparent window plate 140 with the first sensor electrode layer 110.

The configuration of FIG. 3b further comprises a second optically transparent adhesive layer 125 between the polarizer 130 and the display device 200 with the second sensor electrode layer 120. The second optically transparent adhesive layer 125 may fully laminate the polarizer 130 to the display device 200 with the second sensor electrode layer 120.

It will be appreciated that the window integrated type display device may be replaced by an OLED-type display device 201 as shown in FIG. 3c.

FIG. 3c schematically shows a window integrated type configuration of a capacitive touch sensor 100 and an OLED-type display device 201 for an apparatus.

The capacitive touch sensor 100 in FIG. 3c is configured in a similar way as shown in FIG. 3b and described with reference to FIG. 3b, and is hence not described again here.

The OLED-type display device 201 comprises a back plate 192 comprising an active matrix of pixels, a front plate 194, a layer of organic light-emitting material 196 sandwiched between the back plate 192 and the front plate 194, and an optically transparent electrode layer 197 sandwiched between the layer of organic light-emitting material 196 and the front plate 194. The optically transparent electrode layer 197 is arranged to emit light when the active matrix of the back plate 192 drives a current through the layer of organic light-emitting material, the current being driven between the back plate 192 and the electrode layer 197.

Compared to the above described LCD-type display device 200 of FIGS. 3a/3b, the OLED-type display device 201 lacks the backlight system 91, and the LCD layer 96 is replaced by the layer of organic light-emitting material 196 and the optically transparent electrode layer 197.

Here, the polarizer 132 may be a circular polarizer. The circular polarizer may reduce a reflection of ambient light falling into the OLED-type display device 201 and being reflected by the OLED-type display device 201, in particular by the back plate 192.

FIG. 4 schematically shows a capacitive touch sensor 103 and a display device 203 in a window integrated type touch panel.

The apparatus 1 comprises a housing 300 having a transparent window plate 140 covering the capacitive touch sensor 103 for protecting the capacitive touch sensor 103. The capacitive touch sensor 103 comprises an optically clear adhesive (OCA) 133 forming a sensor dielectric layer 130. A first electrode 112 comprising a plurality of first sensor elements 112(1)-112(4) is provided on the transparent window plate 140 in a first sensor electrode layer 110 at a back side of the transparent window plate 140. A second electrode 122 is provided as a single electrode in a second sensor electrode layer 120 on a front surface 402 of the display device 203.

The second electrode 122 is composed of a transparent conductive material, e.g. ITO. In alternative embodiments, the second electrode 122 comprises a thin metal layer, e.g. Au, or an transparent conductive organic layer. The plurality of first sensor elements 112(1)-112(4) and the second electrode 122 are connected via the touch driver 36 to the sensor controller 34 (connections not shown). The sensor controller 34 is arranged to determine a position of a touch input to the transparent window plate 140, coupling to the capacitive touch sensor 103, from the plurality of first sensor elements 112(1)-112(4) of the first electrode 112 and the second electrode 122 using e.g. known methods.

The display device 203 is an LCD-type display comprising, in this example, a back plate 92 comprising an active matrix of pixels, a front plate 94, a polarizer 98, an LCD layer 96 sandwiched between the back plate 92 and front plate 94, and a backlight system 91. The polarizer 98 is provided at a front side of the display device 203 and provides the front surface 402 of the display device 203. The backlight system 91 delivers polarized light to the back plate 92. The backlight 91 system may e.g. comprise a wave guide parallel to the back plate, a light source arranged at a side of the wave guide for emitting light into the waveguide, and an input polarizer between the wave guide and the back plate 92 for delivering polarized light to the back plate 92 (not shown).

It will be appreciated that in alternative embodiments, the display device 203 may be replaced with an OLED-type display device, with a polarizer 98 being provided at a front side of the display device 203 and the polarizer 98 providing the front surface 402 of the display device 203.

The optically clear adhesive (OCA) 133 thus fixates the display device 203 to the transparent window plate 140. As the first sensor electrode layer 110 is provided at the back side of the transparent window plate 140 and the second sensor electrode layer 120 is provided on the front surface 402 of the display device 203, there is no need for applying an intermediate glass plate 83 as was present in the prior art example shown in FIGS. 2a/2b. The display module of FIG. 4 thus lacks the glass plate 83 of FIGS. 2a/2b. As a result, the display module of FIG. 4 may be thinner than the display module of FIGS. 2a/2b, and the display module of FIG. 4 may have an improved image quality compared to the display module of FIGS. 2a/2b.

In embodiments according to FIG. 4, the second electrode 122 is composed of a material which, for its application to the polarizer 98, is compatible with processing steps associated with this application. In an embodiment, the polarizer 98 is a plastic material and the second electrode 122 comprises an ITO layer, which is deposited on the polarizer 98 using a low-temperature ITO-deposition process. In an alternative embodiment, the polarizer 98 is a plastic material and the second electrode 122 comprise a thin metal layer, e.g. Au, which is deposited on the polarizer 98 using e.g. a low-temperature process. In a further alternative embodiment, the polarizer 98 is a plastic material and the second electrode 122 comprises a transparent conductive organic layer, which is deposited on the polarizer 98 using e.g. a spincoating process.

In FIG. 4, small spacings are shown in between the optically clear adhesive (OCA) 133 and the first sensor electrode layer 110 and in between the optically clear adhesive (OCA) 133 and the second sensor electrode layer 120. When the optically clear adhesive (OCA) 133 is adhesive on both faces, it will be appreciated that these spacings are only drawn to clearly indicate that the first and second electrode layers 110, 120 are not provided on the optically clear adhesive (OCA) 133 itself.

It is observed that second electrode 122 may, alternatively, be located on another location within the display device 200.

Although in the above examples reference is made to display panels of the LCD and OLED type, in general the display type may be based on any of twisted nematic (TN) effect technology, in-plane switching (IPS) technology, active-matrix OLED (AMOLED) technology, advanced fringe field switching (AFFS) technology, vertical alignment (VA) or blue phase mode technology.

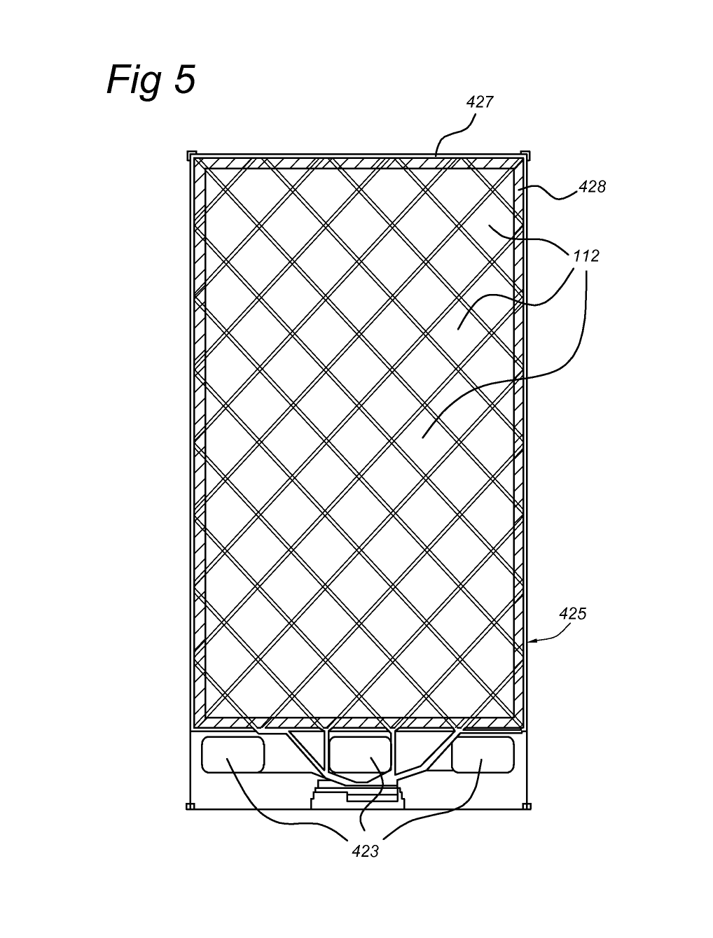

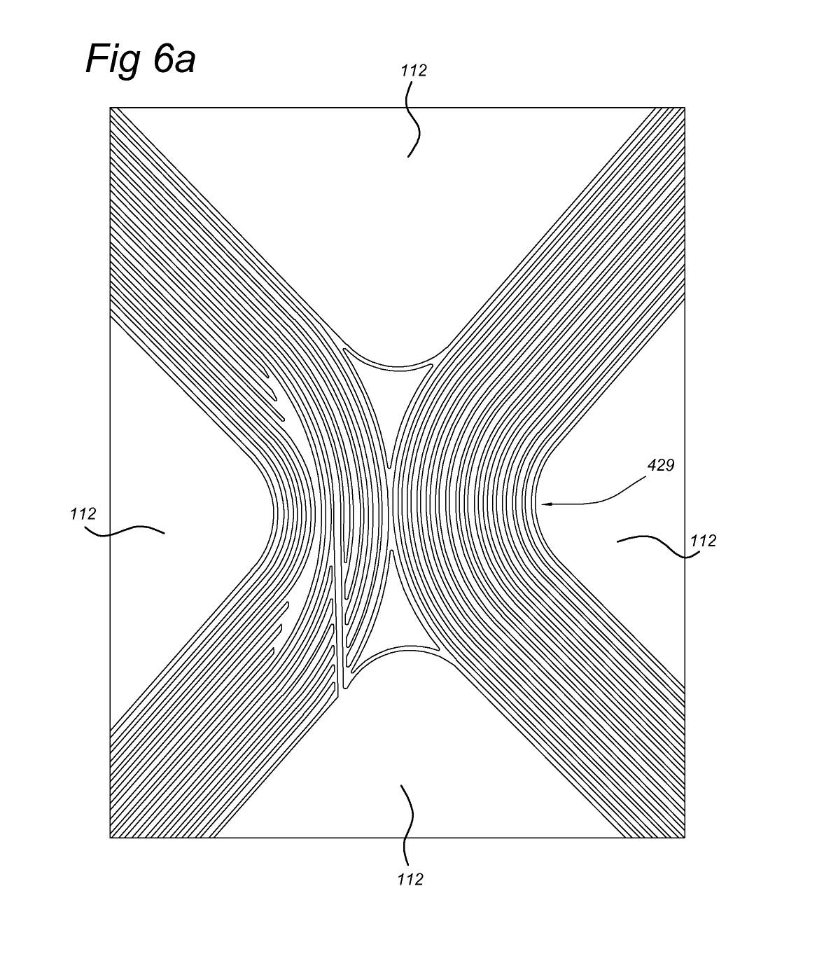

FIG. 5 shows a top view of an embodiment of the touch panel device such that the sensor cells are clearly visible (which in practice are not, of course). The figure is schematic and the sensors cells are not necessarily on scale. FIG. 5 shows an example with 93 sensors 112 (in array) and three additional button sensors 423. The 93 sensors 112 are located in rows and columns arranged transverse oriented relative to sides 425, 427 of the touch panel device, e.g. under an angle of 45° to both sides 425, 427. Such an arrangement is also called “diamond shaped”.

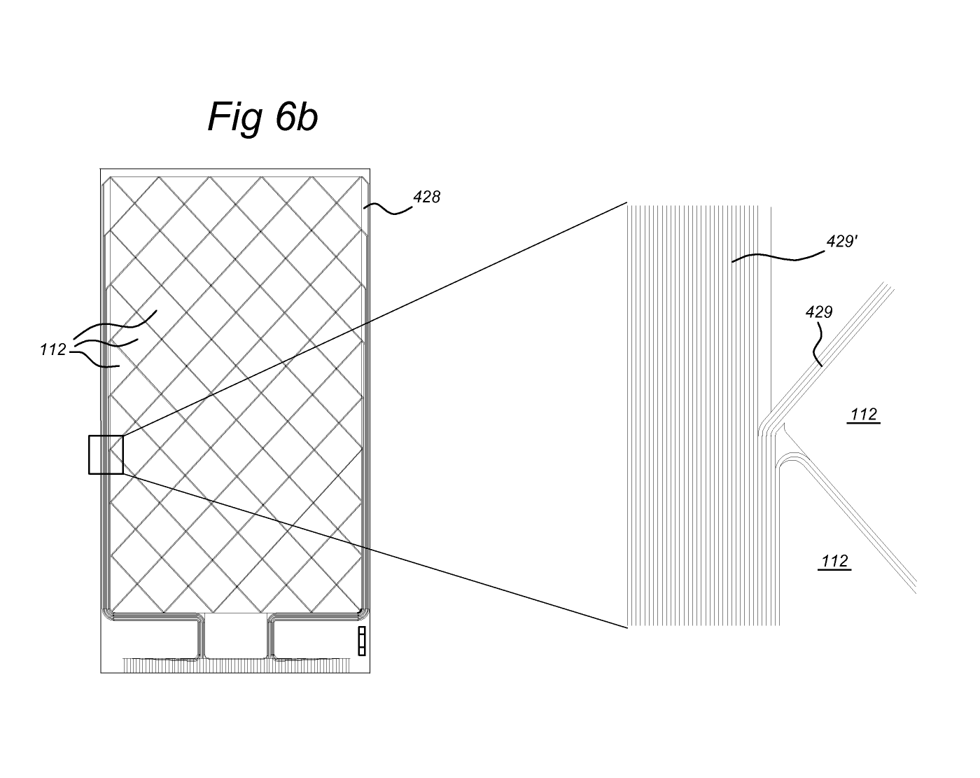

The touch panel device may have a non-transparent layer 428 arranged below the window plate 140, also called “black layer”, e.g. having a thickness of between 1 and 10 μm. Its function may be two-fold: it provides the device with an attractive appearance (like window jambs) but may also function to hide elements/components from being visible to a user. The latter may apply to conductive routing tracks between the sensor cells 112 and the sensor controller 34, as will be further explained with reference to FIG. 6b.

The sensors 112 are intended to sense a touch or movement (gesture) of an object like a finger or stylus and to send corresponding sense signals as produced by such a touch or movement to the sensor controller 34. The button sensors 423 are only intended to sense a touch by an object and send a corresponding sense signal to the sensor controller 34. All sensors are made in one single ITO layer, as will be explained in further detail below.

All sensors 112 are connected to the sensor controller 34 by means of conductive tracks 429. These conductive tracks 429 may be arranged between the sensors 112, as shown in FIG. 6a. I.e., in the embodiment of FIG. 6a, the routing is realized in the gap between the individual sensor diamonds. The minimum dimensions of the tracking may be 15 μm width for the track and 8-10 μm width for the gaps between the tracks 429. Note that this patterned structure does not require any additional contacting bridges or isolation layers and can thus easily be made in a single ITO patterning action.

Button sensors 423 are connected to the sensor controller 34 in a similar way (not shown). Metallization of the tracks 429 from the sensors 112, 423 to the edge of the patterned ITO layer 8 and towards the sensor controller 34 is not required.

In an alternative embodiment, as shown in FIG. 6b, routing may be done on the outside of the touch panel device, i.e. below the non-transparent (or black) layer 428, as much as possible. As shown, the conductive tracks 429 are only present between the sensors 112 where necessary. In this embodiment, the tracks may be manufactured of two different portions, i.e. a first portion of conductive tracks 429 between the sensors 112 and a second portion of conductive tracks 429′ on the outside of the touch panel device, located below the non-transparent layer 428, i.e. in an area where no touch or movement of a finger/stylus or the like will be sensed anyway. The second portion of conductive tracks 429′ may advantageously, at least partly, comprise a suitable metal with a very low electrical resistance, such as Au, Mb, Al. If so, then, large portions of the conductive tracks between the sensors 112 and the sensor controller 34 have a very low resistance such that the resistance requirements for the conductive ITO tracks 429 between the sensors 112 are less severe, and the ITO layer of which these conductive tracks are made may be thinner. This would enhance visibility for users since also the sensor areas themselves can then be made of thinner ITO layer 112.

The ITO requirement is to get an as high as possible transmission for visible light in combination with a lowest possible ITO electrical resistance after processing. The following table provides some possible figures for the ITO layers 112, 122. These figures are only intended as examples and not as limiting the present invention.

| | | | Sensor ITO |
|---|---|---|---|
| | | | layer 112 |
| | Shielding ITO | Sensor ITO | (if metal routing |
| Item | layer 122 | layer 112 | on outside) |
| Thickness | 110 ± 30 Å | 1300 ± 400 Å | 300 ± 100 Å |
| Resistance | ~200 | ~20 | ~100 |
| (ohms/square) | | | |
| Transmission @ | ≧88 | ≧88 | |
| 4550 nm | (High Tr) | (High Tr) | |

In general, the patterned ITO layer 112 may have a thickness between 1000 and 2000 Å, whereas ITO layer 122 may have a thickness between 50 and 200 Å.

The device as described is a discrete coplanar capacitive touch panel device. It can, for instance, be used as part of a 3.5″ display module. The touch panel layers are fully laminated on top of the display layers. It provides an excellent human interface for mobile applications, like handheld smartphones.

The coplanar touch panel device as shown uses differential capacitance measurements in combination with a coplanar touch sensor panel. The technique is tolerant to high series resistance allowing the usage of thin ITO for optimum optical transmission. Coplanar technology applies standard passive LCD display panel processing techniques, i.e. there is no need for additional (metal) bridges, which in turn improves the optical performance. All sensors 112 of the coplanar touch panel may be measured in parallel and will make multi-touch applications easier to implement. This parallel read-out of all the sensors at once reduces (common mode) noise problems.

Coplanar touch is a high performance technology for use in portable applications with a display diagonal size up to approximately 10″, such as used in smartphones and tabloid personal computers. Larger display diagonal sizes can be supported at lower resolution. Coplanar touch technology has an excellent noise immunity and signal-to-noise performance. It has a minimal reduction of the optical performance of the display thanks to the single layer sensor structure and missing bridges and isolation layer. The latency time is short due to the parallel sensing and the cycle frequency is programmable (for instance from 4 Hz up to 153 Hz). The form factor is excellent due to the minimum dead border distances that are achievable. A full laminated module stack-up is preferred, in order to achieve the optimum in sensitivity. The coplanar capacitive touch panels are designed for (multiple) finger input, but a capacitive stylus can also be used. There is no calibration step required at the customer and/or end-user side and the hardware architecture is ready for integration of customer's interface specification.

The detection circuits of the sensor controller 34 measure the capacitance delta between the capacitance of each individual panel sensor 112 and the average capacitance of all panel sensors 112. The detection circuit is based on measurement of charge difference. The sensitivity variations and output offset voltages of the sensor circuits are compensated digitally before touch sensing algorithms are applied. The difference in capacitance between the touch panel sensors 112 and a reference value (i.e. average of all sensors 112) is measured in parallel instead of scanning the sensors 112 sequentially thereby reducing the problem of noise due to it being correlated. The differential sensor produces a voltage output, which is in turn converted into the digital domain by an ADC (analogue digital converter). The time required for a capacitance measurement is dependent on the time constant associated with the capacitance of the sensor 112 and the interconnect resistance of connecting tracks.

In order to manufacture the glass plate 140 with patterned ITO layer 112 on its backside one could use a lithography process as in the prior art. However, sometimes one would wish to use a glass type for glass plate 140 that should be hardened before being used in the final device. This would, for instance, apply to the following glass types: Dragontrail from Asahi or Gorilla Glass from Corning. A problem may then arise in the sense that the hardening should be done after the singulation of the large glass plate, in order to keep/have the desired strength. However, due to the necessary high temperatures, the hardening action can not be performed when the ITO layer is already applied, therefore, the ITO layer has to be applied and patterned on single pieces. The problem that arises is that patterning by means of lithography will be too expensive on single pieces Therefore, another method of patterning needs to be applied.

To solve this, the present invention proposes to change these manufacturing actions in the following way:
a) Provide a larger sheet of glass,
b) Out the larger glass sheet in smaller pieces having a desired size for the intended application, like a screen of a smartphone,
c) Harden the cut smaller pieces of glass to a desired level of hardness,
d) Apply transparent conductive material with a desired thickness on the hardened glass pieces, for instance by means of sputtering,
e) Apply a laser ablation process on the transparent conductive layer to provide the patterned transparent conductive layer 112, as well as the conductive tracks 429, 429′.

If black border 428 is to be present between the glass and the transparent conductive layer, actions 4 and 5 may comprise the following actions:
d1. apply a black border with any suitable known technique on a lower side of the hardened glass pieces. Preferably, nowadays, this is done by means of a direct printing technique such that the black border 428 is directly provided in a desired pattern.
d2. optionally, apply a transparent overcoat layer on the lower side of the glass pieces, which overcoat layer is covering both the black border 428 and the glass pieces area on the lower side not covered by black border 428.
d3. optionally, apply a conductive metal layer, below the black border 428, e.g., by using a masker technique. If action d2 is applied, this metal conductive layer contacts such overcoat material.
d4. apply transparent conductive material with a desired thickness on the lower side of the glass pieces, for instance by means of sputtering. This transparent conductive material is contacting the black border and the lower side of the glass pieces if only action d1 is applied. If action d2 has been applied, this transparent conductive material is contacting the transparent overcoat layer. If action d3 is applied, this transparent conductive material is contacting said conductive metal layer at locations where it is applied.
e′. apply a laser ablation process on the transparent conductive layer to provide the patterned transparent conductive layer 112, as well as the conductive tracks 429, 429′ such that the conductive tracks 429′ are located below the black border and will be invisible for a user. If action d3 has been applied, the conductive metal layer below the black border 428 will be patterned to have the same pattern as conductive tracks 429′.

As a further alternative, a sixth, optional action may be applied:
f) Apply a coating made of a composition to protect the transparent conductive layer like ITO, or to make that ITO less visible for a user.

The product thus manufactured may be called “patterned glass pieces”.

In order to complete a touch panel device of the window integrated type, such a patterned glass piece is applied on a display device, e.g. in accordance with the following actions:
Provide display device 200, 201, 203,
Provide second sensor electrode layer 120 on front surface 202, 402 of display device 200, 201, 203
Provide dielectric layer 130 on top of second sensor electrode layer 120,
Provide a patterned glass piece on top of dielectric layer 130.

As indicated above, between the second sensor electrode layer 120 and the dielectric layer 130, a small gap may be provided (FIG. 3a) or, alternatively, an optically transparent adhesive layer 125 (e.g., FIGS. 3b and 3c). Similarly, between the patterned ITO layer 112 and the dielectric layer 130, a small gap may be provided (FIG. 3a) or, alternatively, an optically transparent adhesive layer 135 (e.g., FIGS. 3b and 3c).

Applying laser ablation to pattern the ITO layer 112 on the cut smaller sized glass sheets has turned out to be surprisingly advantageous since the risk of damaging the small vulnerable glass sheets is lower than with lithographic methods and when applied on small screens it is even cheaper.

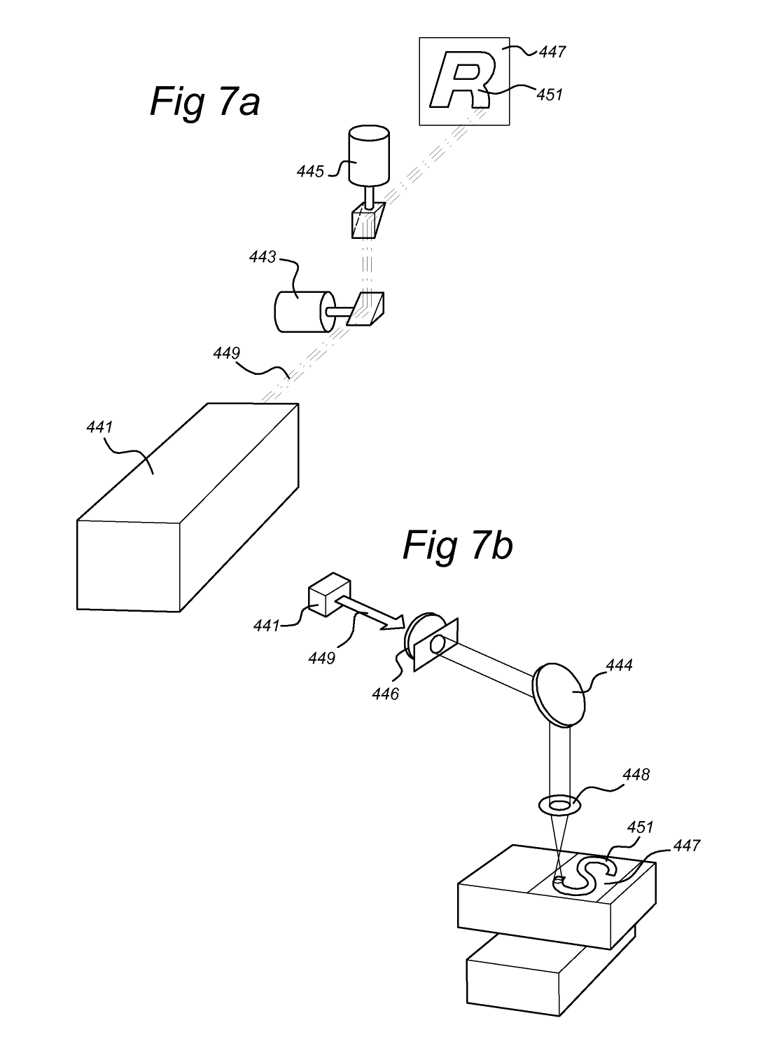

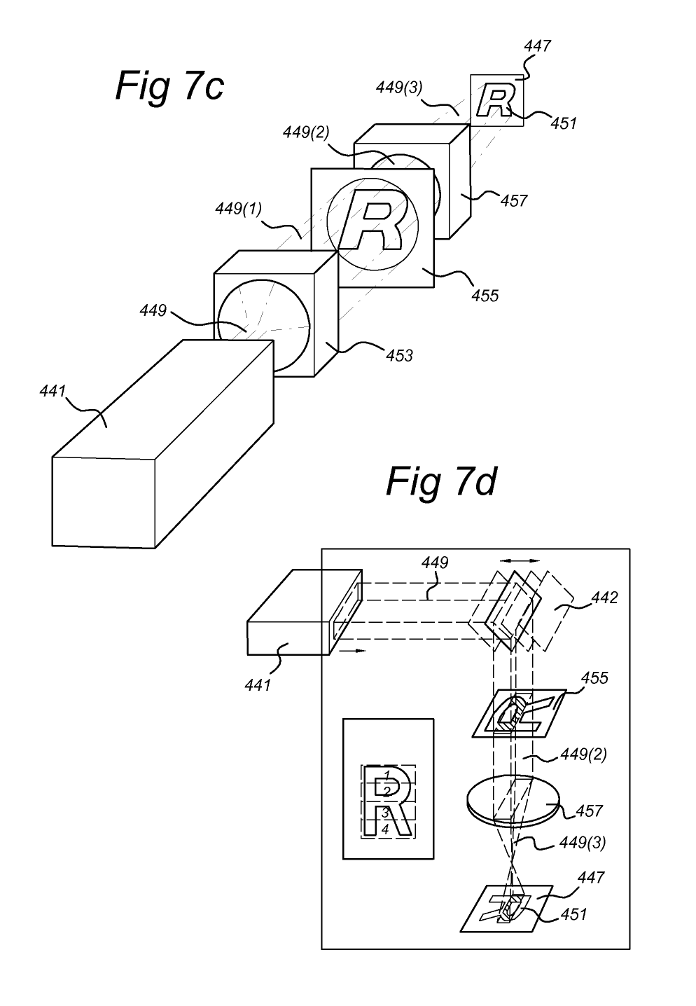

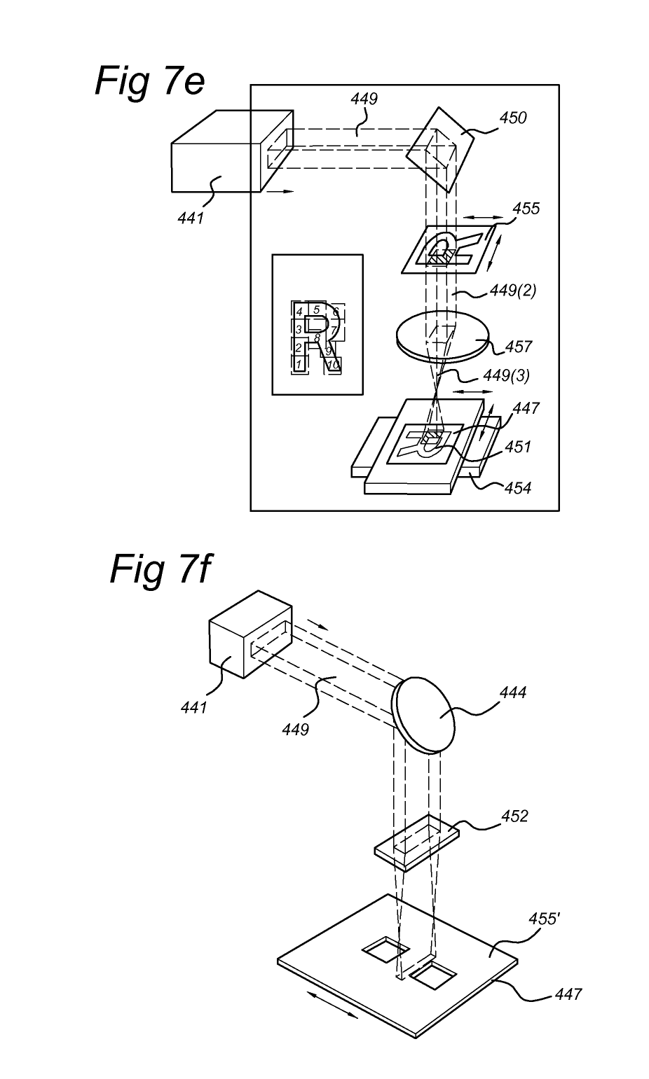

FIGS. 7a to 7f show examples of apparatuses that can be used in a laser ablation method. These apparatuses will be explained with reference to an ITO layer to be laser ablated and to provide a laser ablated, patterned ITO layer. However, as indicated hereinbefore, the ITO layer may be substituted by any suitable transparent conductive layer.

FIGS. 7a and 7b show apparatuses that can be used in a direct-write method whereas FIGS. 7b to 7f show apparatuses based on a mask-projection method.

The apparatus of FIG. 7a comprises a laser unit 441 arranged to produce a laser beam 449. The laser beam has a predetermined wave length suitable to locally remove ITO after being sputtered (or applied in another way) on a glass sheet. Such a suitable wavelength is preferably within a range of 157 nm and 1064 nm, and is e.g. 355 nm.

The apparatus comprises two beam deviating devices, i.e., an y-axis scanner 443 and an x-axis scanner 445. The y-axis scanner 443 is, e.g., provided with a mirror controlled such as to deviate beam 449 in an y-direction whereas x-axis scanner 443 is, e.g., provided with a mirror controlled such as to deviate beam 449 in an x-direction. Together they control a position where laser beam 449 impinges on ITO on glass sheet 447 and is able to locally ablate ITO in order to directly write a desired pattern 451 in the ITO layer.

Laser unit 441, y-scanner 443 and x-scanner 445 are connected to a, non-shown, processor operated by a suitable computer program, stored in a memory, to control the laser beam 449 to write such a desired pattern within the ITO layer.

FIG. 7b shows a similar setup as shown in FIG. 7a. The beam 449 as generated by laser unit 441 may be adapted by an imaging mask 446. The resulting laser bean impinges on a turning mirror 444 of which the orientation is controlled by suitable driving means as controlled by a suitable processor, like in the embodiment of FIG. 7a. The turning mirror 444 is controlled to turn both in a first plane and a perpendicular second plane, such that the laser beam as reflected by turning mirror 444 is moveable in two perpendicular directions. So, the turning mirror 444 can be used to write any desired pattern 451 with the laser beam, possibly further adapted by an imaging lens 448, in the ITO layer on glass sheet 447. Again, this is preferably done by the processor as operated by a suitable computer program, stored in a memory, to control the turning of the turning mirror 444 such that the laser beam 449 writes such a desired pattern within the ITO layer.

FIG. 7c shows that laser ablation can, alternatively, be performed by a mask-projection method. An apparatus able to perform such a mask-projection method comprises laser unit 441 which directs its produced laser beam 449 towards a beam-expanding unit 453 such as to produce an expanded laser beam 449(1). The beam-expanding unit 453 may also comprise homogenization optics to homogenize the produced expanded laser beam 449(1).

The expanded laser beam 449(1) is directed towards a mask 455 with an image of the desired pattern 451 and designed to transmit only a portion of the expanded laser beam 449(1) such that a masked laser beam 449(2) is produced in accordance with the desired pattern 451 in the ITO layer on the glass sheet 447. The masked laser beam 449(2) may be passing an imaging lens system 457 designed to produce an image laser beam 449(3) from the masked laser beam 449(2) which is imaged on the glass sheet 447 such that ITO is locally laser ablated in accordance with the desired pattern.

FIG. 7d shows an alternative laser ablation setup based on a mask-projection method in combination with a moving scanning mirror 442. Here, the laser beam 449 as produced by the laser unit 441 has a width which corresponds at least with the width of the image on mask 455. The laser beam 449 impinges on the scanning mirror 442 which is translated by suitable driving means such as to cause laser beam 449 to scan the image on mask 455 and produce masked laser 449(2). Again, masked laser beam 449(2) is produced in accordance with the desired pattern 451 in the ITO layer on the glass sheet 447. The masked laser beam 449(2) may be passing an imaging lens system 457 designed to produce an image laser beam 449(3) from the masked laser beam 449(2) which is imaged on the glass sheet 447 such that ITO is locally laser ablated in accordance with the desired pattern. The arrangement may comprise a suitable processor connected to the driving means driving scanning mirror 442 and arranged to generate suitable control signals for these driving means. The processor preferably operates under the control of a suitable computer program, stored in a memory.

FIG. 7e shows a variant of the setup of FIG. 7d. Instead of scanning mirror 442, the setup of FIG. 7e uses a fixed mirror 450 to receive laser beam 449. Laser beam 449, in this embodiment, does not have a width at least as large as the width of the image on mask 455. So, fixed mirror 450 reflects laser beam 449 only on a portion of the image on mask 455. In order to allow full imaging of the entire image of mask 455 on the ITO layer on glass sheet 447, both the mask 455 and the glass sheet 447 are driven by suitable driving means to be moveable in two perpendicular directions. To that end, the glass sheet 447 with ITO layer may be supported by an xy stage 454. The driving means are controlled such that when the mask 455 moves in a first direction (e.g. along the x-axis) the xy stage 454 with the glass sheet 447 moves in an opposite direction (also along the x-axis), and when the mask 455 moves in a second direction perpendicular to the first direction (e.g. along the y-axis) the xy stage 454 with the glass sheet 447 moves in an opposite direction (also along the y-axis). Again, the arrangement may comprise a suitable processor connected to the driving means and arranged to generate suitable control signals for these driving means. The processor preferably operates under the control of a suitable computer program, stored in a memory.

FIG. 7f shows a mask method based on contact mask processing. Any desired contact mask process may be used. The one shown here comprises turning mirror 444 which reflects laser beam 449 on a cylindrical lens 452. The beam as produced by cylindrical lens 452 is directed on a contact mask 455′ having the desired image and, in use, contacting the ITO layer on glass sheet 447. The width of the laser beam may be as large as the width of the entire image on mask 455′. However, alternatively the laser beam may be smaller than that such that turning mirror 444 should be driven to write laser beam across the entire image on mask 455′.

It should be evident to persons skilled in the art that the examples of FIGS. 4a to 4f are not provided as being exhaustive examples. Any combination of features of the arrangements shown may be used to arrive at the desired effect of providing a laser ablated pattern in the ITO (or other transparent conductive) layer on glass sheet 447.

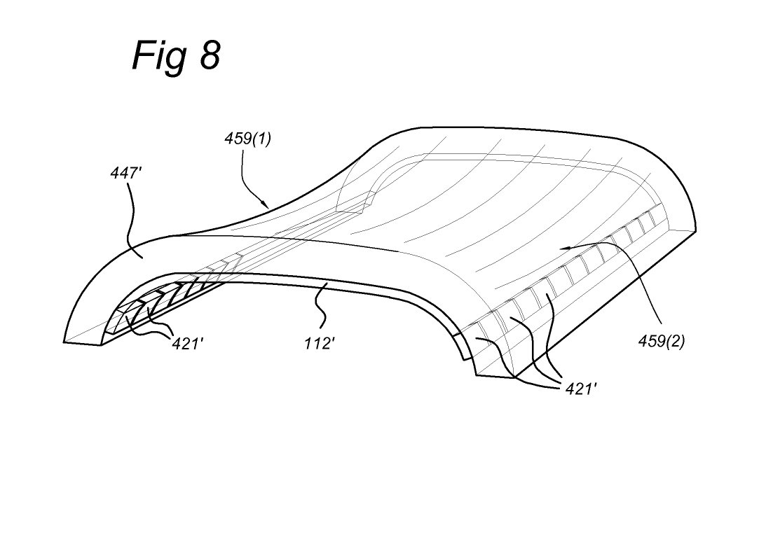

Using laser ablation not only turns out to be cost-effective when applied in the above method but also provides the option of being applied to non-flat glass sheets 447′ with a non-flat ITO layer 112′. An example of such a non-flat glass sheet 447′ with non-flat ITO layer 112′ is shown in FIG. 8. Again, the non-flat ITO layer 112′ is patterned with a predetermined pattern by laser ablation, e.g. with one of the apparatuses shown in FIGS. 7a to 7f. The pattern for the portion relating to the sensors 112′ may be “diamond shaped”. However, any other desired pattern may be applied.

The non-flat glass sheet 447′ with non-flat ITO layer 112′ is part of a non-flat touch panel device which may have essentially the same components as shown in any of the FIGS. 3a-4, however, with shapes matching the shown shape of the glass sheet 447′.

As shown, the shape of the glass sheet 447′, as well as of the patterned ITO layer 112′ on its surface, may be such that it has a larger surface part, say between 70-90% of the total glass sheet surface, that has a relatively small curvature, and two smaller surface parts 459(1), 459(2), say up to a maximum of 30% of the total glass sheet surface, that are strip-shaped and extending in a longitudinal direction of the device and inclined relative to the larger portion such as to function as edges of the device. Such smaller surface parts 459(1), 459(2) may be provided with a series of touch sensors 421′ suitably connected to sensor controller 34. The sensor controller 34 may then be programmed such that when a user sweeps an object, like his finger or a stylus, along the surface of the sensors 421′ this will be interpreted as an instruction to perform a scroll operation on the picture shown on the touch panel.

The shape shown in FIG. 8 is but one shape that can be made. Other three-dimensional shapes are equally possible. E.g. when viewed from the top, the glass sheet may have a shape of a fruit, like a banana or an apple.

When applying a curved, non-flat glass sheet 447′ with curved, non-flat patterned ITO layer 112′ all other layers in the touch panel design as shown in FIGS. 3a-4 will also be non-flat and have a shape matching the curvatures of the glass sheet 447′.

It is observed that the touch panels in accordance with the present invention may have more layers than the ones shown in the figures. For instance, a front side of the window plate 140, which in uses faces a user, may be provided with an anti-smudge/anti-fingerprint coating. Such a layer is known per se from the prior art and need no detailed discussion. Its purpose is to reduce the negative visual influence of dirt sticking to the surface of the touch screen e.g. due to fingerprints left by a user. Any coating suitable for that purpose may be used. Below the anti-smudge/anti-fingerprint coating, an anti-reflective coating may be applied. Any known suitable material may be used for this purpose.

The touch panel device as produced in accordance with the invention may, for instance, be a smartphone or a tabloid personal computer.

Three-dimensional shaped glass objects can be obtained from GPInnovation GmbH. They can provide molded glass sheets in all kinds of geometries with coefficient of thermal expansion (CTE) between 3.2 and 9.0 μm/m*K, glass sheet sizes up to 20″*33″, and a thickness between 0.3 mm and 40 mm. Suitable glass types are Soda Lime Float Glass, Borofloat 33® (Schott), Gorilla Glass® (Corning), and aso.

It is observed that, in the above specification, at several locations reference is made to “controllers” or “processors”. It is to be understood that such controllers/processors may be designed in any desired technology, i.e. analogue or digital or a combination of both. A suitable implementation would be a software controlled processor where such software is stored in a suitable memory present in the touch panel device and connected to the processor/controller. The memory may be arranged as any known suitable form of RAM (random access memory) or ROM (read only memory), where such ROM may be any form of erasable ROM such as EEPROM (electrically erasable ROM). Parts of the software may be embedded. Parts of the software may be stored such as to be updatable e.g. wirelessly as controlled by a server transmitting updates regularly over the air.

It is to be understood that the invention is limited by the annexed claims and its technical equivalents only. In this document and in its claims, the verb “to comprise” and its conjugations are used in their non-limiting sense to mean that items following the word are included, without excluding items not specifically mentioned. In addition, reference to an element by the indefinite article “a” or “an” does not exclude the possibility that more than one of the element is present, unless the context clearly requires that there be one and only one of the elements. The indefinite article “a” or “an” thus usually means “at least one”.

1. A manufacturing method of a capacitive coplanar touch panel device, the manufacturing method comprising the steps of:
a) Providing a glass sheet having a first size;
b) Cutting the glass sheet in glass sheet pieces having a second size smaller than the first size;
c) Hardening the glass sheet pieces with said second size to a desired level of hardness;
d) Applying a transparent conductive layer with a predetermined thickness on a side of at least one glass sheet piece with said second size;
e) Applying a laser ablation process on the transparent conductive layer such as to provide the transparent conductive layer with a predetermined pattern and thus rendering an at least one glass sheet piece with a patterned transparent conductive layer.

2. A manufacturing method as claimed in claim 1, wherein the glass sheet is selected from the following group of glass types: Soda Lime Float Glass, Borofloat 33, or Gorilla Glass.

3. A manufacturing method as claimed in claim 1, wherein the glass sheet has a glass sheet thickness of between 0.5 and 4 mm.

4. A manufacturing method as claimed in claim 3, wherein the glass sheet has a preferably glass sheet thickness of between 0.5 and 1.5 mm.

5. A manufacturing method as claimed in claim 4, wherein the glass sheet has a thickness tolerance of 0.05 mm.

6. A manufacturing method as claimed in claim 1, wherein the transparent comprises a first transparent conductive layer, and the glass sheet and the first transparent conductive layer are both non-flat.

7. A manufacturing method as claimed in claim 6, wherein the first transparent conductive layer has a first transparent conductive layer thickness between 1000 and 2000 Å

8. A manufacturing method as claimed in 1, the laser ablation process comprises using either a direct-write method or a mask-projection method.

9. A manufacturing method as claimed in claim 1, wherein the patterned transparent conductive layer is made of one of ITO and a transparent conductive organic material.

10. A manufacturing method as claimed in claim 1, wherein the patterned transparent conductive layer comprises both sensor elements and conductive tracks to provide routing tracks between said sensor elements and a sensor controller.

11. A manufacturing method as claimed in claim 10, wherein the width of the said tracking for the said track is greater or equal than 15 μm.

12. A manufacturing method as claimed in claim 10, wherein the width for the said gap between the said track is between 8 μm to 10 μm.

13. A manufacturing method as claimed in claim 1, comprising applying a non-transparent border area on an outside area of the at least one glass sheet piece prior to applying said transparent conductive layer.

14. A manufacturing method as claimed in claim 13, comprising applying a metal conductive layer on the non-transparent border area prior to applying the transparent conductive layer, such that the metal conductive layer is laser-ablated together with the transparent conductive layer in the action e) in order to provide conductive routing tracks in the outside area.

15. A manufacturing method as claimed in claim 1, comprising further assembling the touch panel device by:
Providing a product on top of a display device.

16. A manufacturing method as claimed in claim 15, wherein the method of assembling the touch panel device comprises providing a sensor electrode layer in the display device made of one of ITO, a metal, and a transparent conductive organic material.

17. A manufacturing method as claimed in claim 16, wherein the display device is made by one of a twisted nematic (TN) effect technology, an in-plane switching (IPS) technology, an active-matrix OLED (AMOLED) technology, an advanced fringe field switching (AFFS) technology, a vertical alignment (VA) technology and blue phase mode technology.

18. A touch panel device, comprising a window plate having a laser-ablated patterned transparent conductive layer on its back surface, the patterned transparent conductive layer providing a touch sensitive interface area.

19. A touch panel device as claimed in claim 16, wherein the device is non-flat.

20. A apparatus provided with a touch panel device according to claim 18, said apparatus being one of a smart-phone, a tabloid personal computer, a digital still-picture camera, a car navigation system, a DVD/blu ray-player, a gaming device, a tabloid computer monitor, a printer, a scanner and copier.
